(19) United States
(12) Patent Application Publication
(10) Pub. No.: US 2025/0069172 A1
(43) Pub. Date: Feb. 27, 2025

(54) TARGETED ANTI-SCAM EDUCATION AND FEEDBACK

(71) Applicant: Capital One Services, LLC, McLean, VA (US)

(72) Inventors: Ignacio ESPINO, Arlington, VA (US); Mathew VERGHESE, Great Falls, VA (US); Jonathan JURADO, Baltimore, MD (US)

(21) Appl. No.: 18/454,382

(22) Filed: Aug. 23, 2023

(51) Int. Cl. G06Q 50/20; G06Q 30/0204

(52) U.S. Cl. CPC G06Q 50/20; G06Q 30/0205

(57) ABSTRACT

In some implementations, an education system may receive demographic information and account information associated with a user. The education system may generate a risk profile based on the demographic information and the account information. The education system may map the risk profile to at least one threat, out of a plurality of possible threats indicated in a data structure, likely to be targeted to the user. The education system may transmit, to a user device, an educational message that is associated with the at least one threat and that is indicated in the data structure.

### BACKGROUND

One common form of computer attack is a phishing attempt. A phishing attempt includes a communication, sent to a user, that uses impersonation (or another form of trickery or deception) to entice the user to provide a set of credentials to an attacker. Other scam attempts may include communications that entice the user to provide gift cards or cryptocurrency, among other examples, to avoid negative events (e.g., arrest or property seizure).

### SUMMARY

Some implementations described herein relate to a system for generating targeted anti-scam education. The system may include one or more memories and one or more processors communicatively coupled to the one or more memories. The one or more processors may be configured to receive demographic information and account information associated with a user. The one or more processors may be configured to map the demographic information and the account information to at least one threat, out of a plurality of possible threats, likely to be targeted to the user. The one or more processors may be configured to transmit, to a device associated with the user, an indication of the at least one threat. The one or more processors may be configured to receive, from the device associated with the user, an indication of a news story associated with a scam. The one or more processors may be configured to determine, based on the demographic information and the account information, a likelihood that the user will be impacted by the scam. The one or more processors may be configured to transmit, to the device associated with the user, an indication of the likelihood.

Some implementations described herein relate to a method of generating targeted anti-scam education. The method may include receiving demographic information and account information associated with a user. The method may include generating a risk profile based on the demographic information and the account information. The method may include mapping the risk profile to at least one threat, out of a plurality of possible threats indicated in a data structure, likely to be targeted to the user. The method may include transmitting, to a user device, an educational message that is associated with the at least one threat and that is indicated in the data structure.

Some implementations described herein relate to a non-transitory computer-readable medium that stores a set of instructions for providing targeted anti-scam feedback. The set of instructions, when executed by one or more processors of a device, may cause the device to receive demographic information and account information associated with a user. The set of instructions, when executed by one or more processors of the device, may cause the device to generate a risk profile based on the demographic information and the account information. The set of instructions, when executed by one or more processors of the device, may cause the device to receive, from a device associated with the user, an indication of a news story associated with a scam. The set of instructions, when executed by one or more processors of the device, may cause the device to determine, based on the risk profile, a likelihood that the user will be impacted by the scam. The set of instructions, when executed by one or more processors of the device, may cause the device to transmit, to the device associated with the user, an indication of the likelihood.

### BRIEF DESCRIPTION OF THE DRAWINGS

FIGS. 1A-1C are diagrams of an example implementation relating to targeted anti-scam education, in accordance with some embodiments of the present disclosure.

FIGS. 2A-2C are diagrams of an example implementation relating to targeted anti-scam feedback, in accordance with some embodiments of the present disclosure.

FIGS. 3A-3B are diagrams illustrating an example of training and using a machine learning model in connection with building risk profiles, in accordance with some embodiments of the present disclosure.

FIG. 4 is a diagram of an example environment in which systems and/or methods described herein may be implemented, in accordance with some embodiments of the present disclosure.

FIG. 5 is a diagram of example components of one or more devices of FIG. 4, in accordance with some embodiments of the present disclosure.

FIG. 6 is a flowchart of an example process relating to targeted anti-scam education and feedback, in accordance with some embodiments of the present disclosure.

### DETAILED DESCRIPTION

The following detailed description of example implementations refers to the accompanying drawings. The same reference numbers in different drawings may identify the same or similar elements.

In a phishing attempt, an attacker transmits a communication, to a user, that uses impersonation (or another form of trickery or deception) to entice the user to voluntarily provide a set of credentials, associated with the user, to the attacker. For example, the attacker may send an email message impersonating a bank, an insurance company, a merchant, or another legitimate actor and include a hyperlink. The user may follow the hyperlink and provide the set of credentials to the attacker via a website that impersonates the legitimate actor's website. In a debt collection scam, an attacker transmits a communication, to a user, that uses impersonation (or another form of trickery or deception) to entice the user to voluntarily provide a gift card, cryptocurrency, and/or another type of valuable property to the attacker. For example, the attacker may send an email message impersonating a government agency, a medical establishment, or another legitimate actor.

Successful scams, such as phishing attacks or debt collection scams, can result in significant downtime (e.g., by enabling a denial-of-service (DoS) attack). Additionally, or alternatively, remediation of successful scams consumes significant power and processing resources in order to undo actions performed by the attacker. For example, sensitive information, such as account numbers, obtained by the attacker may need to be modified to prevent further damage. In another example, electronic property (e.g., gift cards or cryptocurrency) may be cancelled such that a refund is issued to a victim.

Some implementations described herein enable transmission of targeted anti-scam education to users. For example, the users may be grouped based on various risk attributes such that educational messages are targeted based on risk profiles of the users. As a result, the users are more likely to learn about how to avoid scams, and chances of successful scams are reduced, which conserves power and processing resources that would otherwise be expended on remediating the successful scams. Additionally, or alternatively, some implementations described herein enable targeted anti-scam feedback to users. For example, the users may provide news articles about ongoing scams and receive indications of how likely the users are to be targets (e.g., based on risk profiles of the users). As a result, the users are more likely to stay alert, and chances of successful scams are reduced, which conserves power and processing resources that would otherwise be expended on remediating the successful scams.

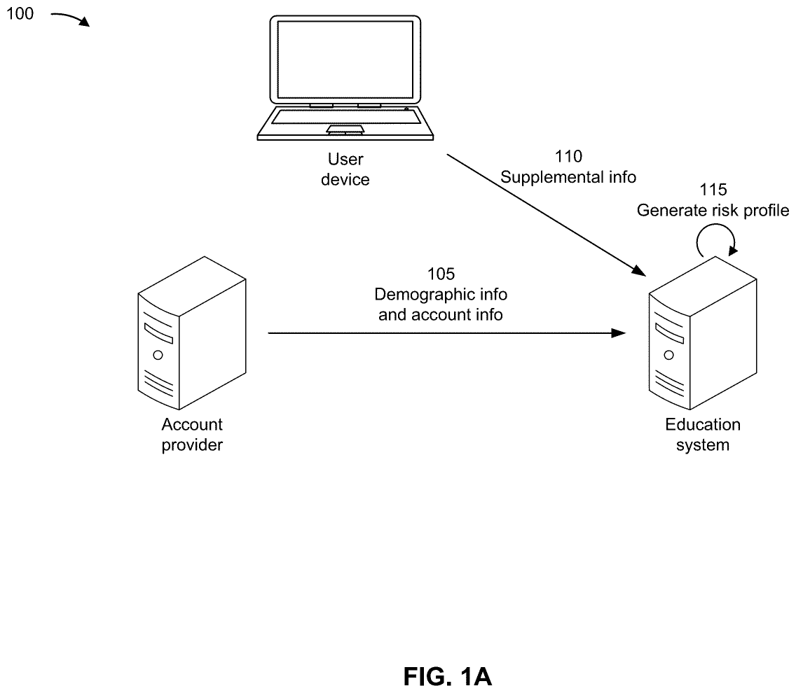

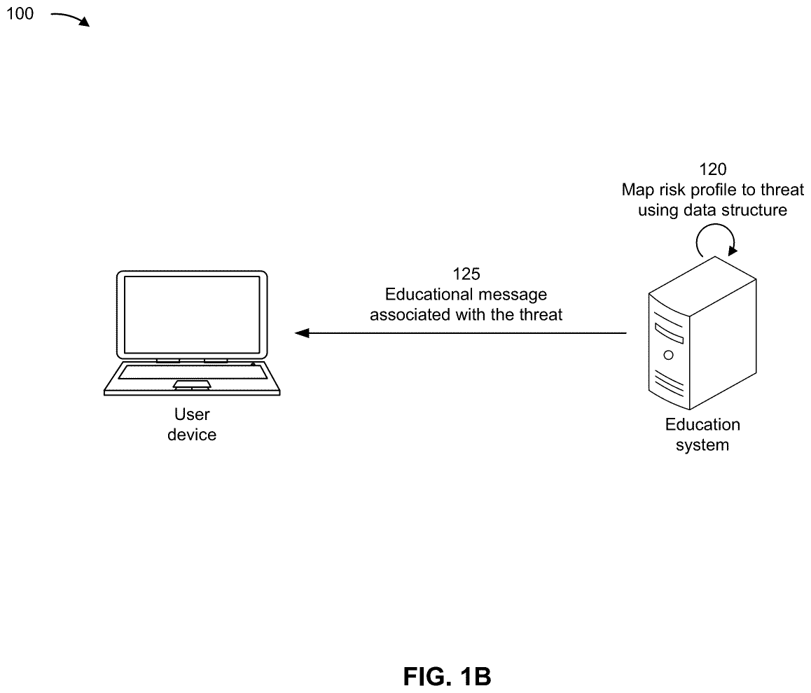

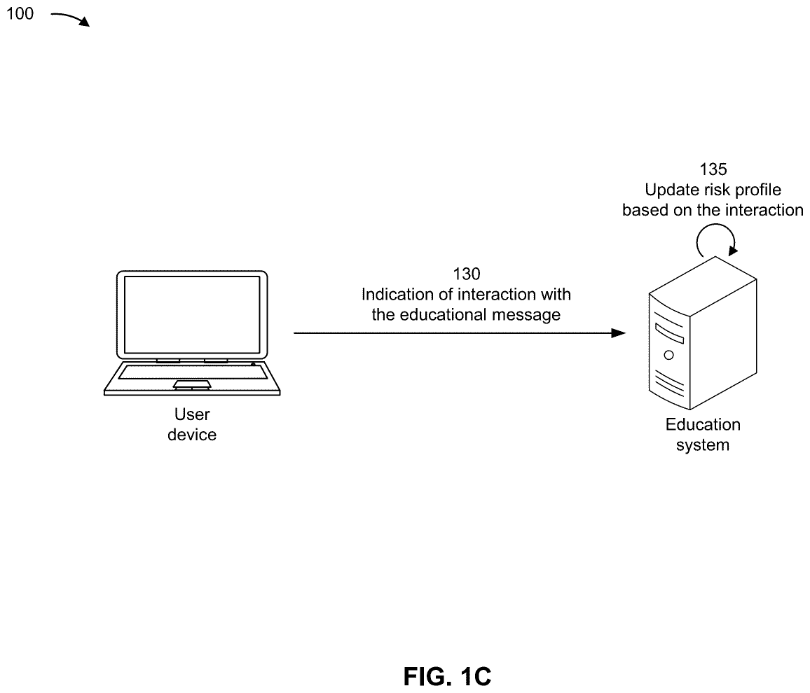

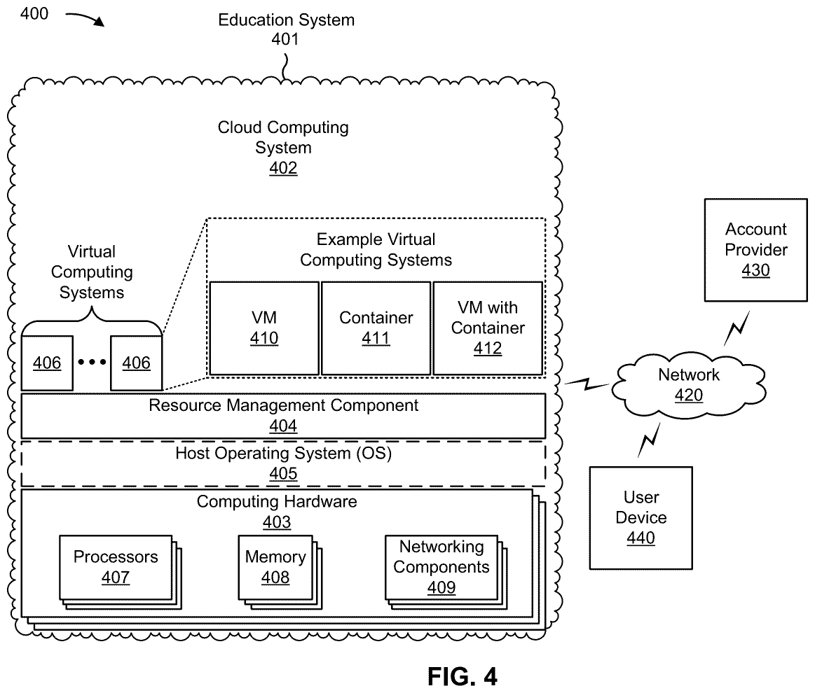

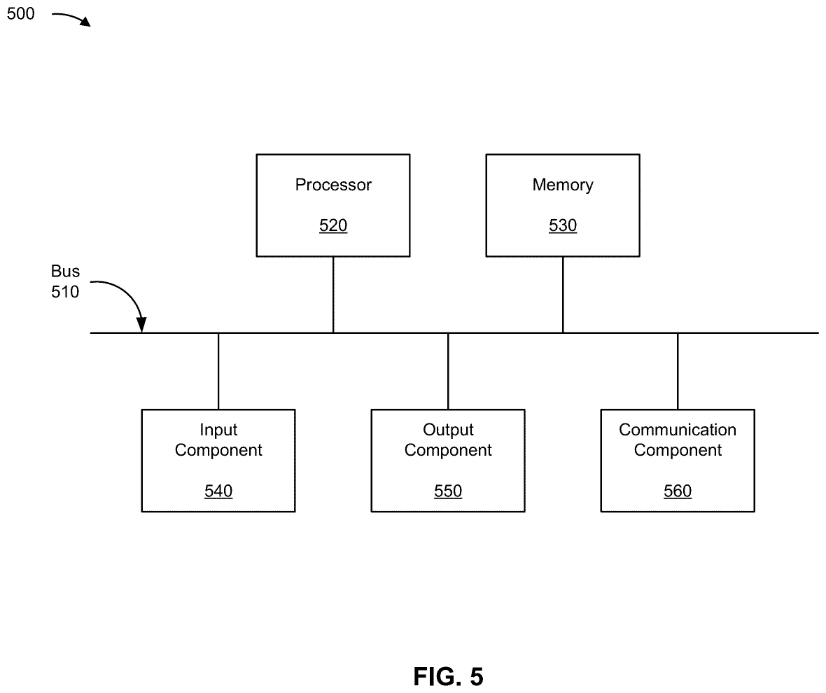

FIGS. 1A-1C are diagrams of an example 100 associated with targeted anti-scam education. As shown in FIGS. 1A-1C, example 100 includes an account provider, an education system, and a user device. These devices are described in more detail in connection with FIGS. 4 and 5.

As shown in FIG. 1A and by reference number 105, the account provider may transmit, and the education system may receive, demographic information and account information associated with a user (e.g., a user of the user device). The demographic information may include an age, a gender, a socioeconomic bracket, or an educational attainment, associated with the user. The account information may include an account type, a balance, or one or more historical transactions.

In some implementations, the education system may transmit, and the account provider may receive, a request (e.g., a hypertext transfer protocol (HTTP) request and/or an application programming interface (API) call) for the demographic information and the account information. The request may include an identifier associated with the user (e.g., a name, a username, an email address, and/or another identifier that is unique to the user, at least relative to other users associated with the account provider). Additionally, the request may include a set of credentials (e.g., a certificate, a key, a token, and/or a username and password, among other examples) associated with the education system. Accordingly, the account provider may authenticate the education system (e.g., by verifying the set of credentials) before transmitting the demographic information and the account information. The set of credentials may be included in the request, or the education system may transmit the set of credentials before transmitting the request (e.g., the account provider may accept the request based on authenticating the education system). In some implementations, an administrator associated with the education system may provide input (e.g., using an input component) that triggers the education system to transmit the request. Additionally, or alternatively, the education system may transmit the request periodically (e.g., according to a schedule).

In some implementations, and as shown by reference number 110, the user device may transmit, and the education system may receive, supplemental information associated with the user. The supplemental information may indicate a preference associated with the user (e.g., whether the user prefers to shop online or in-store and/or whether the user prefers to grocery shop or eat out, among other examples). Additionally, or alternatively, the supplemental information may indicate a habit associated with the user (e.g., how often the user uses a credit card, how often the user uses a debit card, and/or how often the user travels, among other examples).

In some implementations, the education system may transmit, and the user device may receive, a request for the supplemental information. The request may include instructions for a user interface (UI). For example, the user may access a website or a mobile application managed by, or associated with, the education system, and the UI may be shown (or read) to the user based on the instructions. Accordingly, the user may interact with the UI (e.g., using an input component) to trigger the user device to transmit the supplemental information.

As shown by reference number 115, the education system may generate a risk profile based on the demographic information, the account information, and/or the supplemental information. The risk profile may include a numerical measure (e.g., a scalar or a vectorized representation of the user) associated with a risk that the user will be subject to scam attempts.

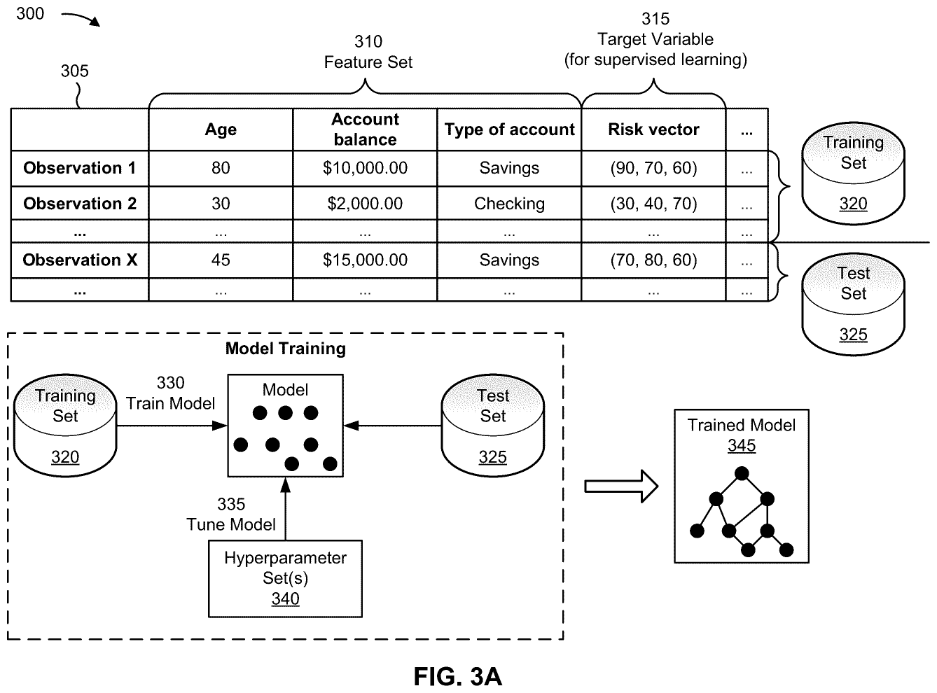

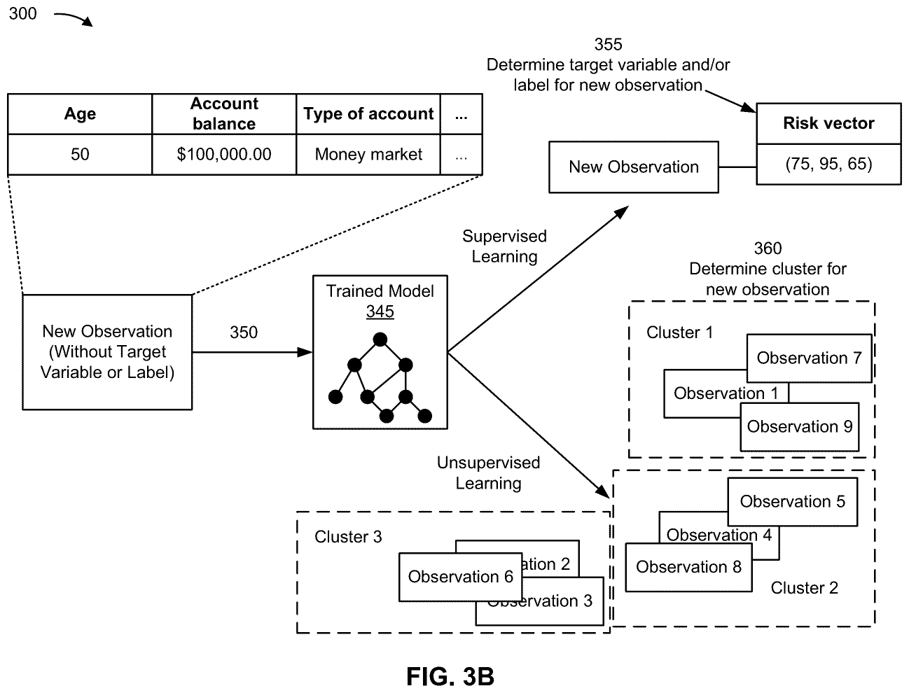

In some implementations, and as described in connection with FIGS. 3A-3B, the education system may apply a machine learning model to vectorized representations of the demographic information, the account information, and/or the supplemental information. For example, the education system may convert a feature of the demographic information, the account information, and/or the supplemental information to a numerical representation along a corresponding dimension. Therefore, the quantity of dimensions associated with the vectorized representations may correspond to the quantity of features used. The machine learning model may output a plurality of scores, based on the vectorized representations, associated with a plurality of categories. For example, one category may be associated with a risk of receiving and/or falling for a phishing email, and thus a score associated with the category may indicate the level of risk of receiving and/or falling for a phishing email. In another example, another category may be associated with a risk of having an account number stolen, and thus a score associated with the category may indicate the level of risk of having an account number stolen.

As shown in FIG. 1B and by reference number 120, the education system may map the risk profile to a threat (e.g., at least one threat), out of a plurality of possible threats indicated in a data structure, likely to be targeted to the user. As used herein, “likely to be targeted” may refer to being associated with a probability (or another quantitative measurement of likelihood) that satisfies a likeliness threshold. Alternatively, “likely to be targeted” may refer to being associated with a qualitative measurement of likelihood (e.g., a letter grade or a category, among other examples) that satisfies a likeliness condition. The data structure may be stored locally (e.g., in a memory controlled by the education system) or at least partially external (e.g., logically, physically, and/or virtually) to the education system. Therefore, the education system may receive the data structure by transmitting a query (e.g., an HTTP request and/or an API call) and receiving the data structure in response (e.g., in an HTTP response and/or returned from an API function).

The data structure may include, for each possible threat, a plurality of scores. Therefore, the education system may map the risk profile to the threat by comparing scores in the risk profile with scores associated with the threat. For example, the education system may determine a plurality of distances, between the risk profile and the plurality of possible threats indicated in the data structure, and may select the threat based on the plurality of distances. The education system may select the threat associated with a smallest distance in the plurality of distances. Additionally, or alternatively, the education system may select multiple threats, from the plurality of possible threats, based on distances associated with the threats satisfying a threat threshold.

Although the example 100 is described using the risk profile, other examples may include the education system directly mapping the demographic information, the account information, and/or the supplemental information to the threat, out of the plurality of possible threats, likely to be targeted to the user. For example, the education system may compare vectorized representations of the demographic information, the account information, and/or the supplemental information to vectors included in the data structure and associated with the plurality of possible threats. Accordingly, the education system may select the threat associated with a smallest distance from the vectorized representations. Additionally, or alternatively, the education system may select multiple threats, from the plurality of possible threats, based on distances from the vectorized representations satisfying a threat threshold.

The education system may transmit, and the user device may receive, an indication of the threat. The indication may be included in a text message (e.g., a short message service (SMS) message and/or a multimedia messaging service (MMS) message, among other examples), an email message (e.g., transmitted via an email provider), and/or a push notification (e.g., for display by a web browser or a mobile application executed by the user device), among other examples. In some implementations, as shown by reference number 125, the education system may transmit, and the user device may receive, an educational message that is associated with the threat. For example, the education system may select the educational message, from a plurality of possible educational messages, using an identifier (e.g., an index) that is associated with the educational message and that is indicated as corresponding to the threat in the data structure. Accordingly, the education system may use a different data structure that stores the plurality of possible educational messages in association with identifiers to obtain the educational message for transmission. Alternatively, the data structure may encode the plurality of possible educational messages in association with the plurality of possible threats.

In some implementations, the educational message may directly include advice (e.g., “The bank will never call you for your two-factor authorization code” or “Phishing emails often include an email address in the ‘From’ line that does not match the alleged sender,” among other examples). Additionally, or alternatively, the educational message may include a hyperlink (e.g., a uniform resource locator (URL)) to an educational module associated with the threat.

Although the example 100 is described in connection with demographic information, account information, and supplemental information associated with an individual person, other examples may include demographic information, account information, and/or supplemental information associated with an organization (e.g., a corporation or a partnership, among other types of business entities). Accordingly, the demographic information may include an age of the organization or a category associated with the organization (e.g., retail, food service, grocery store, or auto mechanic, among other examples). The account information may include expected accounts receivable and/or expected accounts payable. The supplemental information may indicate a habit associated with the organization (e.g., which accounts are generally used to pay certain bills, how many employees have corporate cards, and/or how many employees are remote or hybrid as compared with in-person, among other examples). Therefore, the education system may target the educational message to a manager or an administrator associated with the organization.

The user may interact with the educational message via the user device. For example, the user may use an input component to follow the hyperlink to the educational module, interact with a UI element to confirm that the user read the educational message, or interact with a UI element to close the educational message, among other examples.

As shown in FIG. 1C by reference number 130, the user device may transmit, and the education system may receive, an indication of the interaction with the educational message. Although the example 100 shows the user device indicating the interaction, other examples may additionally or alternatively include a server that indicates the interaction. For example, the server may host the educational module, and the server may transmit an indication of whether the user viewed (and/or completed) the educational module to the education system.

As shown by reference number 135, the education system may update the risk profile based on the indication of the interaction. For example, the education system may increase a score included in the risk profile based on the user interacting with a UI element to close the educational message. On the other hand, the education system may decrease a score included in the risk profile based on the user interacting with a UI element to confirm that the user read the educational message or completed the hyperlinked educational module.

By using techniques as described in connection with FIGS. 1A-1C, the education system provides the educational message to the user based on the risk profile. As a result, the educational message is targeted toward the user such that the user is more likely to learn about how to avoid scams; therefore, chances of scams duping the user are reduced, which conserves power and processing resources that would otherwise be expended on remediating successful scams.

As indicated above, FIGS. 1A-1C are provided as an example. Other examples may differ from what is described with regard to FIGS. 1A-1C.

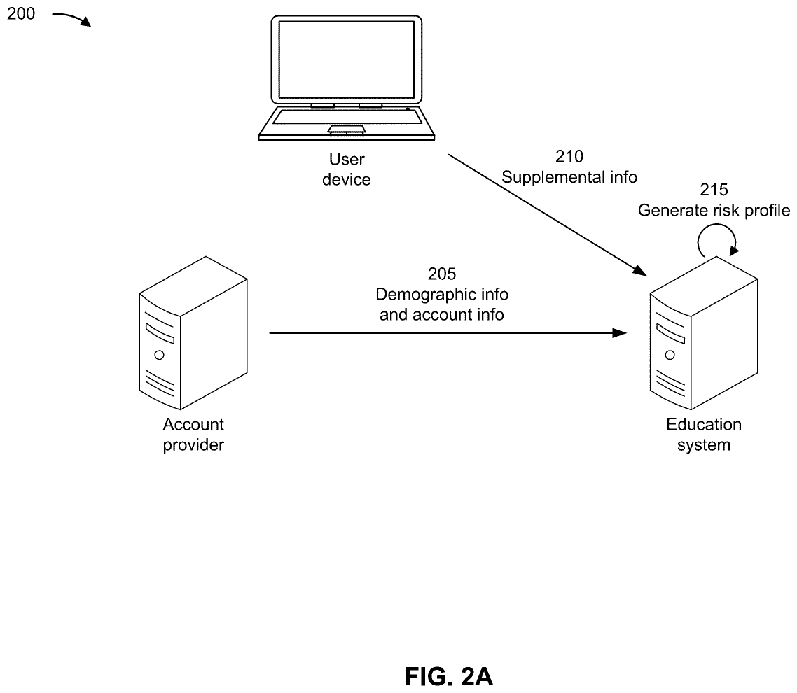

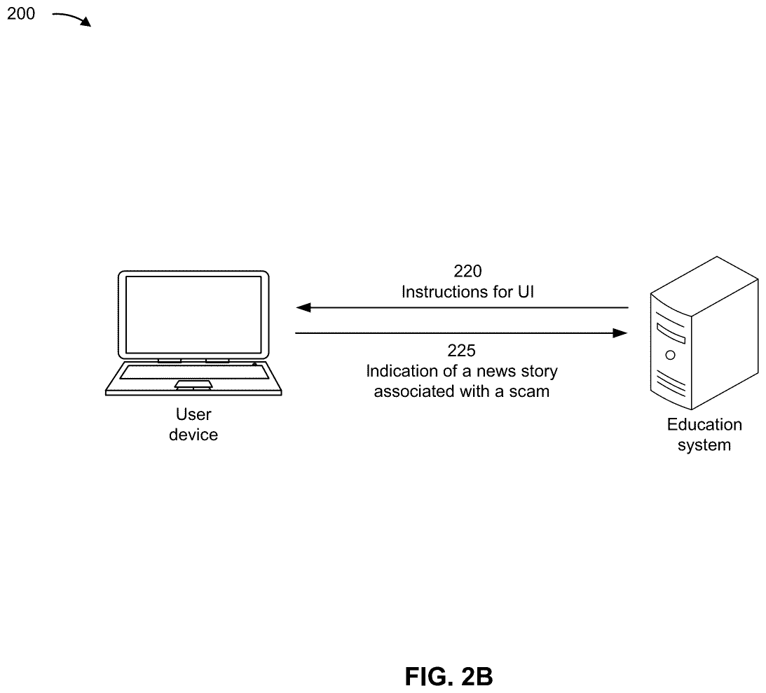

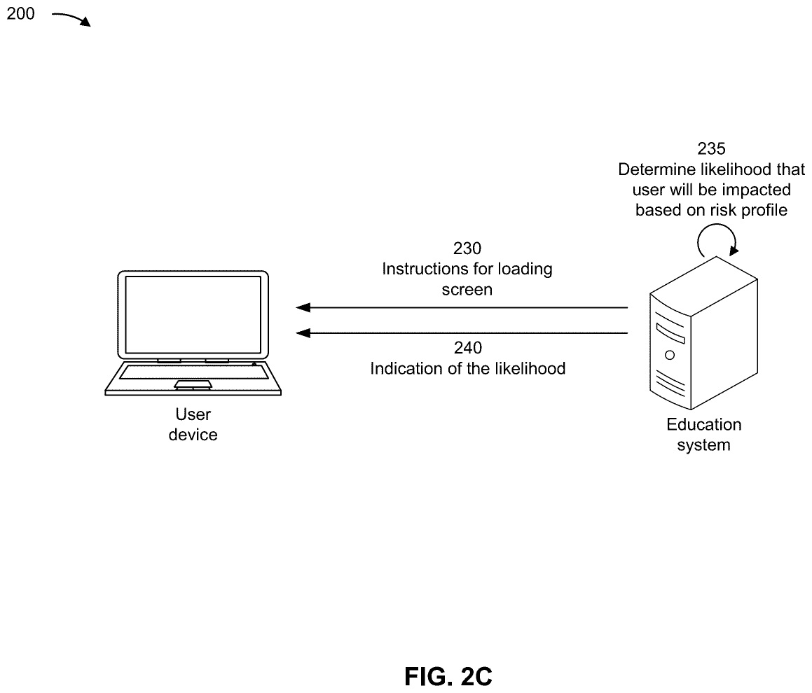

FIGS. 2A-2C are diagrams of an example 100 associated with targeted anti-scam feedback. As shown in FIGS. 2A-2C, example 200 includes an account provider, an education system, and a user device. These devices are described in more detail in connection with FIGS. 4 and 5.

As shown in FIG. 2A and by reference number 205, the account provider may transmit, and the education system may receive, demographic information and account information associated with a user (e.g., a user of the user device). The demographic information may include an age, a gender, a socioeconomic bracket, or an educational attainment, associated with the user. The account information may include an account type, a balance, or one or more historical transactions. The account provider may transmit, and the education system may receive, the demographic information and the account information as described in connection with reference number 105 of FIG. 1A.

In some implementations, and as shown by reference number 210, the user device may transmit, and the education system may receive, supplemental information associated with the user. The supplemental information may indicate a preference associated with the user (e.g., whether the user prefers to shop online or in-store and/or whether the user prefers to grocery shop or eat out, among other examples). Additionally, or alternatively, the supplemental information may indicate a habit associated with the user (e.g., how often the user uses a credit card, how often the user uses a debit card, and/or how often the user travels, among other examples). The user device may transmit, and the education system may receive, the supplemental information as described in connection with reference number 110 of FIG. 1A.

As shown by reference number 215, the education system may generate a risk profile based on the demographic information, the account information, and/or the supplemental information. The risk profile may include a numerical measure (e.g., a scalar or a vectorized representation of the user) associated with a risk that the user will be subject to scam attempts. The education system may generate the risk profile as described in connection with reference number 115 of FIG. 1A.

As shown in FIG. 2B and by reference number 220, the education system may transmit, and the user device may receive, instructions for a UI. The UI may be associated with a website (e.g., accessed via a web browser executed by the user device) or a mobile application (e.g., executed by the user device). In some implementations, the UI may include an input element (e.g., a text box and/or an upload window, among other examples). The input element may be associated with submissions from the user of the user device.

As shown by reference number 225, the user device may transmit, and the education system may receive, an indication of a news story associated with a scam. The indication may include a hyperlink (e.g., a URL) associated with the news story. For example, the user may view the news story and copy-and-paste the URL associated with the news story in order to provide the URL to the education system for additional information.

In some implementations, the education system may receive the indication of the news story via the UI described in connection with reference number 220. For example, the user may input the indication of the news story via the input element, such that the user device may transmit the indication of the news story to the education system.

As shown in FIG. 2C and by reference number 230, the education system may transmit, and the user device may receive, instructions for a loading screen in response to the indication of the news story. The loading screen may be UI displayed (or read) as part of the website or the mobile application. As a result, the user may wait for additional information in response to the news story in near-real-time.

As shown by reference number 235, the education system may determine a likelihood that the user will be impacted by the scam. For example, the education system may determine an identifier associated with the scam (e.g., a name of the scam and/or an index associated with the scam based on the hyperlink, among other examples) based on the news story. The education system may extract the identifier from the news story (e.g., by accessing content of the news story from a server hosting the news story, such as with a domain name system (DNS) call that translates the hyperlink into an Internet protocol (IP) address associated with the server) and/or may map the news story to the identifier (e.g., using a data structure that stores hyperlinks in associated with indices of scams).

Furthermore, the education system may map the identifier associated with the scam to a set of risks using a data structure. The data structure may be stored locally (e.g., in a memory controlled by the education system) or at least partially external (e.g., logically, physically, and/or virtually) to the education system. Therefore, the education system may receive the data structure by transmitting a query (e.g., an HTTP request and/or an API call) and receiving the data structure in response (e.g., in an HTTP response and/or returned from an API function).

The data structure may indicate a plurality of possible scams and may indicate, for each possible scam, a set of risks associated with the possible scam. For example, the set of risks may include vectorized representations along a same set of dimensions as the risk profile of the user. Therefore, the education system may determine the likelihood based on a distance between the set of risks and the risk profile. Additionally, or alternatively, the education system may determine a set of risks associated with the scam by applying a machine learning model to the news story (e.g., trained and applied similarly as described in connection with FIGS. 3A-3B). Accordingly, content of the news story (e.g., accessed from the server hosting the news story) may be vectorized into a set of risks using the machine learning model for comparison to the risk profile (e.g., to determine the likelihood, as described above).

Although the example 100 is described using the risk profile, other examples may include the education system directly mapping the demographic information, the account information, and/or the supplemental information to the set of risks. For example, the education system may compare vectorized representations of the demographic information, the account information, and/or the supplemental information to vectors representing the set of risks. Accordingly, the education system may determine the likelihood based on distance between the vectorized representations and the vectors representing the set of risks.

As shown by reference number 240, the education system may transmit, and the user device may receive, an indication of the likelihood. The education system may transmit the indication based on determining the likelihood (e.g., providing the indication in near-real-time, as described above). The indication may be included in a text message (e.g., an SMS message and/or an MMS message, among other examples), an email message (e.g., transmitted via an email provider), and/or a pop-up window (e.g., for display by a web browser or a mobile application executed by the user device), among other examples.

In some implementations, the indication of the likelihood may additionally include an educational message that is associated with the scam. For example, the education system may select the educational message, from a plurality of possible educational messages, using an identifier (e.g., an index) that is associated with the educational message and that is indicated in the data structure. Accordingly, the education system may use a different data structure that stores the plurality of possible educational messages in association with identifiers to obtain the educational message for transmission. Alternatively, the data structure may encode the plurality of possible educational messages in association with the set of risks. In some implementations, the educational message may directly include advice (e.g., “This scam relies on folks answering calls from unrecognized phone numbers” or “This scam targets people with brokerage accounts,” among other examples). Additionally, or alternatively, the educational message may include a hyperlink (e.g., a URL) to an educational module associated with the scam.

By using techniques as described in connection with FIGS. 2A-2C, the education system may provide near-real-time feedback to the user about the news story. As a result, the education system may indicate how likely the user is to be a target (e.g., based on the risk profile associated with the user). As a result, the user is more likely to stay alert, and chances of scams duping the user are reduced, which conserves power and processing resources that would otherwise be expended on remediating successful scams.

As indicated above, FIGS. 2A-2C are provided as an example. Other examples may differ from what is described with regard to FIGS. 2A-2C.

FIGS. 3A-3B are diagrams illustrating an example 300 of training and using a machine learning model in connection with building risk profiles for targeted anti-scam education and feedback. The machine learning model training described herein may be performed using a machine learning system. The machine learning system may include or may be included in a computing device, a server, a cloud computing environment, or the like, such as the education system described herein.

As shown in FIG. 2A and by reference number 305, a machine learning model may be trained using a set of observations. The set of observations may be obtained and/or input from training data (e.g., historical data), such as data gathered during one or more processes described herein. For example, the set of observations may include data gathered from the account provider and/or the user device, as described elsewhere herein. In some implementations, the machine learning system may receive the set of observations (e.g., as input) from the education system.

As shown by reference number 310, a feature set may be derived from the set of observations. The feature set may include a set of variables. A variable may be referred to as a feature. A specific observation may include a set of variable values corresponding to the set of variables. A set of variable values may be specific to an observation. In some cases, different observations may be associated with different sets of variable values, sometimes referred to as feature values. In some implementations, the machine learning system may determine variables for a set of observations and/or variable values for a specific observation based on input received from the education system. For example, the machine learning system may identify a feature set (e.g., one or more features and/or corresponding feature values) from structured data input to the machine learning system, such as by extracting data from a particular column of a table, extracting data from a particular field of a form and/or a message, and/or extracting data received in a structured data format. Additionally, or alternatively, the machine learning system may receive input from an operator to determine features and/or feature values. In some implementations, the machine learning system may perform natural language processing and/or another feature identification technique to extract features (e.g., variables) and/or feature values (e.g., variable values) from text (e.g., unstructured data) input to the machine learning system, such as by identifying keywords and/or values associated with those keywords from the text.

As an example, a feature set for a set of observations may include a first feature of age, a second feature of account balance, a third feature of a type of account, and so on. As shown, for a first observation, the first feature may have a value of 80, the second feature may have a value of $10,000, the third feature may have a value of savings, and so on. These features and feature values are provided as examples, and may differ in other examples. For example, the feature set may include one or more of the following features: a user preference, a user habit, a socioeconomic bracket of the user, a race of the user, a gender identity of the user, a domicile of the user, a level of security associated with a password, and/or whether a user uses two-factor authentication, among other examples. In some implementations, the machine learning system may pre-process and/or perform dimensionality reduction to reduce the feature set and/or combine features of the feature set to a minimum feature set. A machine learning model may be trained on the minimum feature set, thereby conserving resources of the machine learning system (e.g., processing resources and/or memory resources) used to train the machine learning model.

As shown by reference number 315, the set of observations may be associated with a target variable. The target variable may represent a variable having a numeric value (e.g., an integer value or a floating point value), may represent a variable having a numeric value that falls within a range of values or has some discrete possible values, may represent a variable that is selectable from one of multiple options (e.g., one of multiples classes, classifications, or labels), or may represent a variable having a Boolean value (e.g., 0 or 1, True or False, Yes or No), among other examples. A target variable may be associated with a target variable value, and a target variable value may be specific to an observation. In some cases, different observations may be associated with different target variable values. In example 300, the target variable is a risk vector, which has a value of (90, 70, 60) for the first observation.

The feature set and target variable described above are provided as examples, and other examples may differ from what is described above. For example, for a target variable of likelihood that a user will be impacted by a scam, the feature set may include a form of communication associated with the scam, a category associated with the scam, demographic information associated with victims of the scam, and/or a location associated with the scam, among other examples.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model or a predictive model. When the target variable is associated with continuous target variable values (e.g., a range of numbers), the machine learning model may employ a regression technique. When the target variable is associated with categorical target variable values (e.g., classes or labels), the machine learning model may employ a classification technique.

In some implementations, the machine learning model may be trained on a set of observations that do not include a target variable (or that include a target variable, but the machine learning model is not being executed to predict the target variable). This may be referred to as an unsupervised learning model, an automated data analysis model, or an automated signal extraction model. In this case, the machine learning model may learn patterns from the set of observations without labeling or supervision, and may provide output that indicates such patterns, such as by using clustering and/or association to identify related groups of items within the set of observations.

As further shown, the machine learning system may partition the set of observations into a training set 320 that may include a first subset of observations, of the set of observations, and a test set 325 that may include a second subset of observations of the set of observations. The training set 320 may be used to train (e.g., fit or tune) the machine learning model, while the test set 325 may be used to evaluate a machine learning model that is trained using the training set 320. For example, for supervised learning, the test set 325 may be used for initial model training using the first subset of observations, and the test set 325 may be used to test whether the trained model accurately predicts target variables in the second subset of observations. In some implementations, the machine learning system may partition the set of observations into the training set 320 and the test set 325 by including a first portion or a first percentage of the set of observations in the training set 320 (e.g., 75%, 80%, or 85%, among other examples) and including a second portion or a second percentage of the set of observations in the test set 325 (e.g., 25%, 20%, or 15%, among other examples). In some implementations, the machine learning system may randomly select observations to be included in the training set 320 and/or the test set 325.

As shown by reference number 330, the machine learning system may train a machine learning model using the training set 320. This training may include executing, by the machine learning system, a machine learning algorithm to determine a set of model parameters based on the training set 320. In some implementations, the machine learning algorithm may include a regression algorithm (e.g., linear regression or logistic regression), which may include a regularized regression algorithm (e.g., Lasso regression, Ridge regression, or Elastic-Net regression). Additionally, or alternatively, the machine learning algorithm may include a decision tree algorithm, which may include a tree ensemble algorithm (e.g., generated using bagging and/or boosting), a random forest algorithm, or a boosted trees algorithm. A model parameter may include an attribute of a machine learning model that is learned from data input into the model (e.g., the training set 320). For example, for a regression algorithm, a model parameter may include a regression coefficient (e.g., a weight). For a decision tree algorithm, a model parameter may include a decision tree split location, as an example.

As shown by reference number 335, the machine learning system may use one or more hyperparameter sets 340 to tune the machine learning model. A hyperparameter may include a structural parameter that controls execution of a machine learning algorithm by the machine learning system, such as a constraint applied to the machine learning algorithm. Unlike a model parameter, a hyperparameter is not learned from data input into the model. An example hyperparameter for a regularized regression algorithm may include a strength (e.g., a weight) of a penalty applied to a regression coefficient to mitigate overfitting of the machine learning model to the training set 320. The penalty may be applied based on a size of a coefficient value (e.g., for Lasso regression, such as to penalize large coefficient values), may be applied based on a squared size of a coefficient value (e.g., for Ridge regression, such as to penalize large squared coefficient values), may be applied based on a ratio of the size and the squared size (e.g., for Elastic-Net regression), and/or may be applied by setting one or more feature values to zero (e.g., for automatic feature selection). Example hyperparameters for a decision tree algorithm include a tree ensemble technique to be applied (e.g., bagging, boosting, a random forest algorithm, and/or a boosted trees algorithm), a number of features to evaluate, a number of observations to use, a maximum depth of each decision tree (e.g., a number of branches permitted for the decision tree), or a number of decision trees to include in a random forest algorithm.

To train a machine learning model, the machine learning system may identify a set of machine learning algorithms to be trained (e.g., based on operator input that identifies the one or more machine learning algorithms and/or based on random selection of a set of machine learning algorithms), and may train the set of machine learning algorithms (e.g., independently for each machine learning algorithm in the set) using the training set 320. The machine learning system may tune each machine learning algorithm using one or more hyperparameter sets 340 (e.g., based on operator input that identifies hyperparameter sets 340 to be used and/or based on randomly generating hyperparameter values). The machine learning system may train a particular machine learning model using a specific machine learning algorithm and a corresponding hyperparameter set 340. In some implementations, the machine learning system may train multiple machine learning models to generate a set of model parameters for each machine learning model, where each machine learning model corresponds to a different combination of a machine learning algorithm and a hyperparameter set 340 for that machine learning algorithm.

In some implementations, the machine learning system may perform cross-validation when training a machine learning model. Cross validation can be used to obtain a reliable estimate of machine learning model performance using only the training set 320, and without using the test set 325, such as by splitting the training set 320 into a number of groups (e.g., based on operator input that identifies the number of groups and/or based on randomly selecting a number of groups) and using those groups to estimate model performance. For example, using k-fold cross-validation, observations in the training set 320 may be split into k groups (e.g., in order or at random). For a training procedure, one group may be marked as a hold-out group, and the remaining groups may be marked as training groups. For the training procedure, the machine learning system may train a machine learning model on the training groups and then test the machine learning model on the hold-out group to generate a cross-validation score. The machine learning system may repeat this training procedure using different hold-out groups and different test groups to generate a cross-validation score for each training procedure. In some implementations, the machine learning system may independently train the machine learning model k times, with each individual group being used as a hold-out group once and being used as a training group k−1 times. The machine learning system may combine the cross-validation scores for each training procedure to generate an overall cross-validation score for the machine learning model. The overall cross-validation score may include, for example, an average cross-validation score (e.g., across all training procedures), a standard deviation across cross-validation scores, or a standard error across cross-validation scores.

In some implementations, the machine learning system may perform cross-validation when training a machine learning model by splitting the training set into a number of groups (e.g., based on operator input that identifies the number of groups and/or based on randomly selecting a number of groups). The machine learning system may perform multiple training procedures and may generate a cross-validation score for each training procedure. The machine learning system may generate an overall cross-validation score for each hyperparameter set 340 associated with a particular machine learning algorithm. The machine learning system may compare the overall cross-validation scores for different hyperparameter sets 340 associated with the particular machine learning algorithm, and may select the hyperparameter set 340 with the best (e.g., highest accuracy, lowest error, or closest to a desired threshold) overall cross-validation score for training the machine learning model. The machine learning system may then train the machine learning model using the selected hyperparameter set 340, without cross-validation (e.g., using all of data in the training set 320 without any hold-out groups), to generate a single machine learning model for a particular machine learning algorithm. The machine learning system may then test this machine learning model using the test set 325 to generate a performance score, such as a mean squared error (e.g., for regression), a mean absolute error (e.g., for regression), or an area under receiver operating characteristic curve (e.g., for classification). If the machine learning model performs adequately (e.g., with a performance score that satisfies a threshold), then the machine learning system may store that machine learning model as a trained machine learning model 345 to be used to analyze new observations, as described below in connection with FIG. 3B.

In some implementations, the machine learning system may perform cross-validation, as described above, for multiple machine learning algorithms (e.g., independently), such as a regularized regression algorithm, different types of regularized regression algorithms, a decision tree algorithm, or different types of decision tree algorithms. Based on performing cross-validation for multiple machine learning algorithms, the machine learning system may generate multiple machine learning models, where each machine learning model has the best overall cross-validation score for a corresponding machine learning algorithm. The machine learning system may then train each machine learning model using the entire training set 320 (e.g., without cross-validation), and may test each machine learning model using the test set 325 to generate a corresponding performance score for each machine learning model. The machine learning model may compare the performance scores for each machine learning model, and may select the machine learning model with the best (e.g., highest accuracy, lowest error, or closest to a desired threshold) performance score as the trained machine learning model 345.

FIG. 3B illustrates applying the trained machine learning model 345 to a new observation. As shown by reference number 350, the machine learning system may receive a new observation (or a set of new observations), and may input the new observation to the machine learning model 345. As shown, the new observation may include a first feature of 50, a second feature of $100,000, a third feature of money market, and so on, as an example. The machine learning system may apply the trained machine learning model 345 to the new observation to generate an output (e.g., a result). The type of output may depend on the type of machine learning model and/or the type of machine learning task being performed. For example, the output may include a predicted (e.g., estimated) value of target variable (e.g., a value within a continuous range of values, a discrete value, a label, a class, or a classification), such as when supervised learning is employed. Additionally, or alternatively, the output may include information that identifies a cluster to which the new observation belongs and/or information that indicates a degree of similarity between the new observation and one or more prior observations (e.g., which may have previously been new observations input to the machine learning model and/or observations used to train the machine learning model), such as when unsupervised learning is employed.

In some implementations, the trained machine learning model 345 may predict a value of (75, 95, 65) for the target variable of risk vector for the new observation, as shown by reference number 355. Based on this prediction (e.g., based on the value having a particular label or classification or based on the value satisfying or failing to satisfy a threshold), the machine learning system may provide a recommendation and/or output for determination of a recommendation, such as recommending an educational module associated with scams that target users with a lot of savings. Additionally, or alternatively, the machine learning system may perform an automated action and/or may cause an automated action to be performed (e.g., by instructing another device to perform the automated action), such as transmitting a hyperlink to an educational module associated with scams that target users with a lot of savings. As another example, if the machine learning system were to predict a value of (75, 95, 95) for the target variable of risk vector, then the machine learning system may provide a different recommendation (e.g., recommending an educational module associated with scams that target users with prepaid accounts) and/or may perform or cause performance of a different automated action (e.g., transmitting a hyperlink to an educational module associated with scams that target users with prepaid accounts). In some implementations, the recommendation and/or the automated action may be based on the target variable value having a particular label (e.g., classification or categorization) and/or may be based on whether the target variable value satisfies one or more threshold (e.g., whether the target variable value is greater than a threshold, is less than a threshold, is equal to a threshold, or falls within a range of threshold values).

In some implementations, the trained machine learning model 345 may classify (e.g., cluster) the new observation in a cluster, as shown by reference number 360. The observations within a cluster may have a threshold degree of similarity. As an example, if the machine learning system classifies the new observation in a first cluster (e.g., a cluster associated with frequent debit card usage), then the machine learning system may provide a first recommendation, such as recommending an educational module associated with scams that target debit card users. Additionally, or alternatively, the machine learning system may perform a first automated action and/or may cause a first automated action to be performed (e.g., by instructing another device to perform the automated action) based on classifying the new observation in the first cluster, such as transmitting a hyperlink to an educational module associated with scams that target debit card users. As another example, if the machine learning system were to classify the new observation in a second cluster (e.g., a cluster associated with users having brokerage accounts), then the machine learning system may provide a second (e.g., different) recommendation (e.g., recommending an educational module associated with scams that target stock owners) and/or may perform or cause performance of a second (e.g., different) automated action, such as transmitting a hyperlink to an educational module associated with scams that target stock owners.

The recommendations, actions, and clusters described above are provided as examples, and other examples may differ from what is described above. For example, the clusters associated with different scams may include, for example, scams that target online shoppers, scams that target travelers, or scams that target iPhone® owners, among many others.

In this way, the machine learning system may apply a rigorous and automated process to generating risk profiles. The machine learning system may enable recognition and/or identification of tens, hundreds, thousands, or millions of features and/or feature values for tens, hundreds, thousands, or millions of observations, thereby increasing accuracy and consistency and reducing delay associated with generating risk profiles relative to requiring computing resources to be apply regular expressions (or “regexes”) using the features or feature values.

As indicated above, FIGS. 3A-3B are provided as an example. Other examples may differ from what is described in connection with FIGS. 3A-3B. For example, the machine learning model may be trained using a different process than what is described in connection with FIG. 3A. Additionally, or alternatively, the machine learning model may employ a different machine learning algorithm than what is described in connection with FIGS. 3A-3B, such as a Bayesian estimation algorithm, a k-nearest neighbor algorithm, an a priori algorithm, a k-means algorithm, a support vector machine algorithm, a neural network algorithm (e.g., a convolutional neural network algorithm), and/or a deep learning algorithm.

FIG. 4 is a diagram of an example environment 400 in which systems and/or methods described herein may be implemented. As shown in FIG. 4, environment 400 may include an education system 401, which may include one or more elements of and/or may execute within a cloud computing system 402. The cloud computing system 402 may include one or more elements 403-412, as described in more detail below. As further shown in FIG. 4, environment 400 may include a network 420, an account provider 430, and/or a user device 440. Devices and/or elements of environment 400 may interconnect via wired connections and/or wireless connections.

The cloud computing system 402 may include computing hardware 403, a resource management component 404, a host operating system (OS) 405, and/or one or more virtual computing systems 406. The cloud computing system 402 may execute on, for example, an Amazon Web Services® platform, a Microsoft Azure® platform, or a Snowflake® platform. The resource management component 404 may perform virtualization (e.g., abstraction) of computing hardware 403 to create the one or more virtual computing systems 406. Using virtualization, the resource management component 404 enables a single computing device (e.g., a computer or a server) to operate like multiple computing devices, such as by creating multiple isolated virtual computing systems 406 from computing hardware 403 of the single computing device. In this way, computing hardware 403 can operate more efficiently, with lower power consumption, higher reliability, higher availability, higher utilization, greater flexibility, and lower cost than using separate computing devices.

The computing hardware 403 may include hardware and corresponding resources from one or more computing devices. For example, computing hardware 403 may include hardware from a single computing device (e.g., a single server) or from multiple computing devices (e.g., multiple servers), such as multiple computing devices in one or more data centers. As shown, computing hardware 403 may include one or more processors 407, one or more memories 408, and/or one or more networking components 409. Examples of a processor, a memory, and a networking component (e.g., a communication component) are described elsewhere herein.

The resource management component 404 may include a virtualization application (e.g., executing on hardware, such as computing hardware 403) capable of virtualizing computing hardware 403 to start, stop, and/or manage one or more virtual computing systems 406. For example, the resource management component 404 may include a hypervisor (e.g., a bare-metal or Type 1 hypervisor, a hosted or Type 2 hypervisor, or another type of hypervisor) or a virtual machine monitor, such as when the virtual computing systems 406 are virtual machines 410. Additionally, or alternatively, the resource management component 404 may include a container manager, such as when the virtual computing systems 406 are containers 411. In some implementations, the resource management component 404 executes within and/or in coordination with a host operating system 405.

A virtual computing system 406 may include a virtual environment that enables cloud-based execution of operations and/or processes described herein using computing hardware 403. As shown, a virtual computing system 406 may include a virtual machine 410, a container 411, or a hybrid environment 412 that includes a virtual machine and a container, among other examples. A virtual computing system 406 may execute one or more applications using a file system that includes binary files, software libraries, and/or other resources required to execute applications on a guest operating system (e.g., within the virtual computing system 406) or the host operating system 405.

Although the education system 401 may include one or more elements 403-412 of the cloud computing system 402, may execute within the cloud computing system 402, and/or may be hosted within the cloud computing system 402, in some implementations, the education system 401 may not be cloud-based (e.g., may be implemented outside of a cloud computing system) or may be partially cloud-based. For example, the education system 401 may include one or more devices that are not part of the cloud computing system 402, such as device 500 of FIG. 5, which may include a standalone server or another type of computing device. The education system 401 may perform one or more operations and/or processes described in more detail elsewhere herein.

The network 420 may include one or more wired and/or wireless networks. For example, the network 420 may include a cellular network, a public land mobile network (PLMN), a local area network (LAN), a wide area network (WAN), a private network, the Internet, and/or a combination of these or other types of networks. The network 420 enables communication among the devices of the environment 400.

The account provider 430 may include one or more devices capable of receiving, generating, storing, processing, and/or providing information associated with demographic information and/or account information, as described elsewhere herein. The account provider 430 may include a communication device and/or a computing device. For example, the account provider 430 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The account provider 430 may communicate with one or more other devices of environment 400, as described elsewhere herein.

The user device 440 may include one or more devices capable of receiving, generating, storing, processing, and/or providing information associated with supplemental information and/or news story indications, as described elsewhere herein. The user device 440 may include a communication device and/or a computing device. For example, the user device 440 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The user device 440 may communicate with one or more other devices of environment 400, as described elsewhere herein.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of the environment 400 may perform one or more functions described as being performed by another set of devices of the environment 400.

FIG. 5 is a diagram of example components of a device 500 associated with targeted anti-scam education and feedback. The device 500 may correspond to an account provider 430 and/or a user device 440. In some implementations, the account provider 430 and/or the user device 440 may include one or more devices 500 and/or one or more components of the device 500. As shown in FIG. 5, the device 500 may include a bus 510, a processor 520, a memory 530, an input component 540, an output component 550, and/or a communication component 560.

The bus 510 may include one or more components that enable wired and/or wireless communication among the components of the device 500. The bus 510 may couple together two or more components of FIG. 5, such as via operative coupling, communicative coupling, electronic coupling, and/or electric coupling. For example, the bus 510 may include an electrical connection (e.g., a wire, a trace, and/or a lead) and/or a wireless bus. The processor 520 may include a central processing unit, a graphics processing unit, a microprocessor, a controller, a microcontroller, a digital signal processor, a field-programmable gate array, an application-specific integrated circuit, and/or another type of processing component. The processor 520 may be implemented in hardware, firmware, or a combination of hardware and software. In some implementations, the processor 520 may include one or more processors capable of being programmed to perform one or more operations or processes described elsewhere herein.

The memory 530 may include volatile and/or nonvolatile memory. For example, the memory 530 may include random access memory (RAM), read only memory (ROM), a hard disk drive, and/or another type of memory (e.g., a flash memory, a magnetic memory, and/or an optical memory). The memory 530 may include internal memory (e.g., RAM, ROM, or a hard disk drive) and/or removable memory (e.g., removable via a universal serial bus connection). The memory 530 may be a non-transitory computer-readable medium. The memory 530 may store information, one or more instructions, and/or software (e.g., one or more software applications) related to the operation of the device 500. In some implementations, the memory 530 may include one or more memories that are coupled (e.g., communicatively coupled) to one or more processors (e.g., processor 520), such as via the bus 510. Communicative coupling between a processor 520 and a memory 530 may enable the processor 520 to read and/or process information stored in the memory 530 and/or to store information in the memory 530.

The input component 540 may enable the device 500 to receive input, such as user input and/or sensed input. For example, the input component 540 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 550 may enable the device 500 to provide output, such as via a display, a speaker, and/or a light-emitting diode. The communication component 560 may enable the device 500 to communicate with other devices via a wired connection and/or a wireless connection. For example, the communication component 560 may include a receiver, a transmitter, a transceiver, a modem, a network interface card, and/or an antenna.

The device 500 may perform one or more operations or processes described herein. For example, a non-transitory computer-readable medium (e.g., memory 530) may store a set of instructions (e.g., one or more instructions or code) for execution by the processor 520. The processor 520 may execute the set of instructions to perform one or more operations or processes described herein. In some implementations, execution of the set of instructions, by one or more processors 520, causes the one or more processors 520 and/or the device 500 to perform one or more operations or processes described herein. In some implementations, hardwired circuitry may be used instead of or in combination with the instructions to perform one or more operations or processes described herein. Additionally, or alternatively, the processor 520 may be configured to perform one or more operations or processes described herein. Thus, implementations described herein are not limited to any specific combination of hardware circuitry and software.

The number and arrangement of components shown in FIG. 5 are provided as an example. The device 500 may include additional components, fewer components, different components, or differently arranged components than those shown in FIG. 5. Additionally, or alternatively, a set of components (e.g., one or more components) of the device 500 may perform one or more functions described as being performed by another set of components of the device 500.

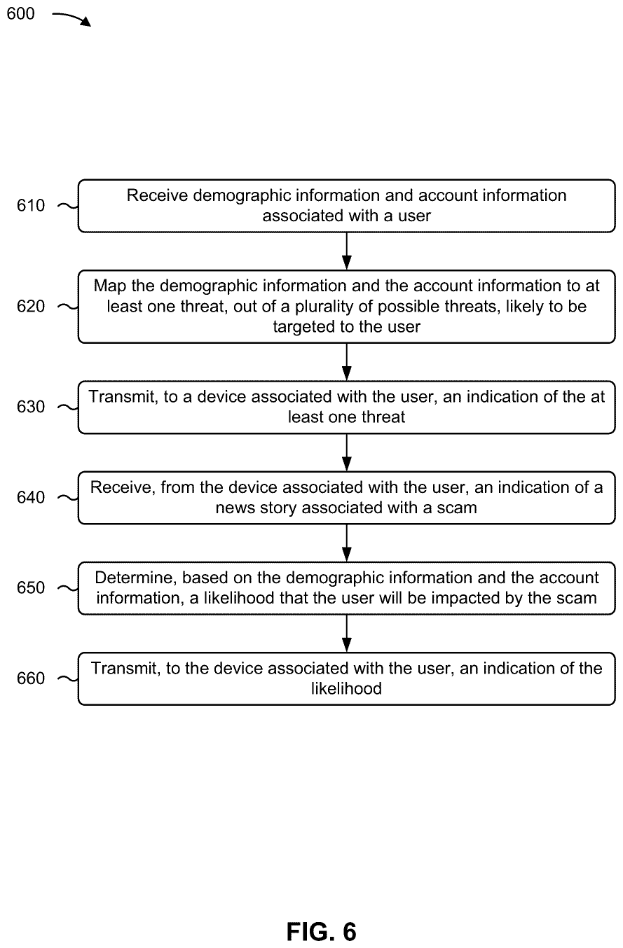

FIG. 6 is a flowchart of an example process 600 associated with targeted anti-scam education and feedback. In some implementations, one or more process blocks of FIG. 6 may be performed by the education system 401. In some implementations, one or more process blocks of FIG. 6 may be performed by another device or a group of devices separate from or including the education system 401, such as the account provider 430 and/or the user device 440. Additionally, or alternatively, one or more process blocks of FIG. 6 may be performed by one or more components of the device 500, such as processor 520, memory 530, input component 540, output component 550, and/or communication component 560.

As shown in FIG. 6, process 600 may include receiving demographic information and account information associated with a user (block 610). For example, the education system 401 (e.g., using processor 520, memory 530, input component 540, and/or communication component 560) may receive demographic information and account information associated with a user, as described above in connection with reference number 105 of FIG. 1A. As an example, the education system may transmit a request (e.g., an HTTP request and/or an API call) for the demographic information and the account information, and an account provider may transmit a response including the demographic information and the account information (e.g., in an HTTP response and/or returned from an API function).

As further shown in FIG. 6, process 600 may include mapping the demographic information and the account information to at least one threat, out of a plurality of possible threats, likely to be targeted to the user (block 620). For example, the education system 401 (e.g., using processor 520 and/or memory 530) may map the demographic information and the account information to at least one threat, out of a plurality of possible threats, likely to be targeted to the user, as described above in connection with reference number 120 of FIG. 1B. As an example, the education system may compare vectorized representations of the demographic information and the account information to vectors included in the data structure and associated with the plurality of possible threats.

As further shown in FIG. 6, process 600 may include transmitting, to a device associated with the user, an indication of the at least one threat (block 630). For example, the education system 401 (e.g., using processor 520, memory 530, and/or communication component 560) may transmit, to a device associated with the user, an indication of the at least one threat, as described above in connection with reference number 125 of FIG. 1B. As an example, the education system may transmit, and the device associated with the user may receive, an educational message that is associated with the at least one threat. In some implementations, the educational message may directly include advice and/or a hyperlink to an educational module associated with the at least one threat.

As further shown in FIG. 6, process 600 may include receiving, from the device associated with the user, an indication of a news story associated with a scam (block 640). For example, the education system 401 (e.g., using processor 520, memory 530, input component 540, and/or communication component 560) may receive, from the device associated with the user, an indication of a news story associated with a scam, as described above in connection with reference number 225 of FIG. 2B. As an example, the education system may receive the indication of the news story via a UI displayed (or read) by the device associated with the user. For example, the user may input the indication of the news story, via an input element of the UI, for transmission to the education system.

As further shown in FIG. 6, process 600 may include determining, based on the demographic information and the account information, a likelihood that the user will be impacted by the scam (block 650). For example, the education system 401 (e.g., using processor 520 and/or memory 530) may determine, based on the demographic information and the account information, a likelihood that the user will be impacted by the scam, as described above in connection with reference number 235 of FIG. 2C. As an example, the education system may compare vectorized representations of the demographic information and the account information to vectors representing a set of risks associated with the scam (e.g., mapped to an identifier of the scam in a data structure and/or determined using a machine learning model).

As further shown in FIG. 6, process 600 may include transmitting, to the device associated with the user, an indication of the likelihood (block 660). For example, the education system 401 (e.g., using processor 520, memory 530, and/or communication component 560) may transmit, to the device associated with the user, an indication of the likelihood, as described above in connection with reference number 240 of FIG. 2C. As an example, the indication may be included in a text message (e.g., an SMS message and/or an MMS message, among other examples), an email message (e.g., transmitted via an email provider), and/or a pop-up window (e.g., for display by a web browser or a mobile application executed by the user device), among other examples.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 1A-1C, 2A-2C, and/or 3A-3B. Moreover, while the process 600 has been described in relation to the devices and components of the preceding figures, the process 600 can be performed using alternative, additional, or fewer devices and/or components. Thus, the process 600 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

In some implementations, an individual processor may perform all of the functions described as being performed by the one or more processors. In some implementations, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more processors described herein. Reference to “one or more memories” should be understood to refer to any one or more memories described herein. For example, functions described as being performed by one or more memories can be performed by the same subset of the one or more memories or different subsets of the one or more memories.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for generating targeted anti-scam education, the system comprising:
one or more memories; and
one or more processors, communicatively coupled to the one or more memories, configured to:
receive demographic information and account information associated with a user;
map the demographic information and the account information to at least one threat, out of a plurality of possible threats, likely to be targeted to the user;
transmit, to a device associated with the user, an indication of the at least one threat;
receive, from the device associated with the user, an indication of a news story associated with a scam;
determine, based on the demographic information and the account information, a likelihood that the user will be impacted by the scam; and
transmit, to the device associated with the user, an indication of the likelihood.

2. The system of claim 1, wherein the one or more processors, to receive the indication of the news story, are configured to:
transmit instructions for an input element of a mobile application or a website; and
receive the indication of the news story via the input element.

3. The system of claim 1, wherein the one or more processors, to transmit the indication of the at least one threat, are configured to:
transmit a hyperlink to an educational module associated with the at least one threat.

4. The system of claim 1, wherein the one or more processors, to transmit the indication of the likelihood, are configured to:
transmit instructions for a pop-up window indicating the likelihood.

5. The system of claim 1, wherein the demographic information includes an age, a gender, a socioeconomic bracket, or an educational attainment, associated with the user.

6. The system of claim 1, wherein the account information includes an account type, a balance, or one or more historical transactions.

7. A method of generating targeted anti-scam education, comprising:
receiving demographic information and account information associated with a user;
generating a risk profile based on the demographic information and the account information;
mapping the risk profile to at least one threat, out of a plurality of possible threats indicated in a data structure, likely to be targeted to the user; and
transmitting, to a user device, an educational message that is associated with the at least one threat and that is indicated in the data structure.

8. The method of claim 7, further comprising:
receiving an indication of an interaction with the educational message; and
updating the risk profile based on the indication of the interaction.

9. The method of claim 7, wherein generating the risk profile comprises:
applying a machine learning model to vectorized representations of the demographic information and the account information,
wherein the risk profile includes a plurality of scores, associated with a plurality of categories, output by the machine learning model.

10. The method of claim 9, wherein mapping the risk profile to the at least one threat comprises:
determining a plurality of distances between the risk profile and the plurality of possible threats indicated in the data structure; and
selecting the at least one threat based on the plurality of distances.

11. The method of claim 7, wherein transmitting the educational message comprises:
transmitting instructions for a push notification to the user device.

12. The method of claim 7, further comprising:
selecting the educational message, from a plurality of possible educational messages, using an identifier, associated with the educational message, indicated as corresponding to the at least one threat in the data structure.

13. The method of claim 7, further comprising:
receiving, from the user device, supplemental information associated with the user,
wherein the risk profile is further based on the supplemental information.

14. A non-transitory computer-readable medium storing a set of instructions for providing targeted anti-scam feedback, the set of instructions comprising:
one or more instructions that, when executed by one or more processors of a device, cause the device to:
receive demographic information and account information associated with a user;
generate a risk profile based on the demographic information and the account information;
receive, from a device associated with the user, an indication of a news story associated with a scam;
determine, based on the risk profile, a likelihood that the user will be impacted by the scam; and
transmit, to the device associated with the user, an indication of the likelihood.

15. The non-transitory computer-readable medium of claim 14, wherein the one or more instructions, when executed, cause the device to:
transmit, to the device associated with the user, instructions for a user interface (UI) associated with a website or a mobile application,
wherein the indication of the news story is received via the UI.

16. The non-transitory computer-readable medium of claim 14, wherein the one or more instructions, that cause the device to receive the indication of the news story, cause the device to:
receive, from the device associated with the user, a hyperlink associated with the news story.

17. The non-transitory computer-readable medium of claim 14, wherein the one or more instructions, that cause the device to determine the likelihood that the user will be impacted by the scam, cause the device to:
determine an identifier associated with the scam based on the news story;
map the identifier associated with the scam to a set of risks using a data structure; and
determine the likelihood based on a distance between the set of risks and the risk profile.

18. The non-transitory computer-readable medium of claim 14, wherein the one or more instructions, that cause the device to determine the likelihood that the user will be impacted by the scam, cause the device to:
determine a set of risks associated with the scam by applying a machine learning model to the news story; and
determine the likelihood based on a distance between the set of risks and the risk profile.

19. The non-transitory computer-readable medium of claim 14, wherein the one or more instructions, when executed, cause the device to:
transmit instructions for a loading screen in response to receiving the indication of the news story,
wherein the indication of the likelihood is transmitted based on determining the likelihood.

20. The non-transitory computer-readable medium of claim 14, wherein the one or more instructions, when executed, cause the device to:
receive, from the device associated with the user, supplemental information associated with the user,
wherein the risk profile is further based on the supplemental information.
